(19) United States
(12) Patent Application Publication
(10) Pub. No.: US 2010/0154052 A1
(43) Pub. Date: Jun. 17, 2010

(54) DATA DELIVERY SYSTEM, DATA DELIVERY DEVICE, DATA DELIVERY METHOD AND RECORDING MEDIUM ALLOWING DATA DELIVERY CONVENIENT FOR USERS

(75) Inventors: Kenji Matsuhara, Kawanishi-Shi (JP); Kei Shigehisa, Amagasaki-shi (JP); Takeshi Morikawa, Takarazuka-shi (JP); Toshimichi Iwai, Kitakatsuragi-gun (JP)

Correspondence Address: MORRISON & FOERSTER LLP, 1650 TYSONS BOULEVARD, SUITE 400, MCLEAN, VA, 22102, US

(73) Assignee: Konica Minolta Business Technologies, Inc., Tokyo (JP)

(21) Appl. No.: 12/638,722

(22) Filed: Dec. 15, 2009

(30) Foreign Application Priority Data
Dec. 16, 2008 (JP) 2008-319829

(51) Int. Cl. H04L 9/32

(52) U.S. Cl. 726/17

(57) ABSTRACT

A CPU obtains a leading page of data stored in an HDD and executes delivery. Then, the CPU determines whether a single-delivery stop command is received or not. When the CPU determines that the single-delivery stop command is received, it executes the single-delivery stop processing. The CPU determines whether an all-delivery stop command is received or not. When the all-delivery stop command is received, the CPU executes all-delivery stop/resume processing. When the all-delivery stop processing command is not received, CPU determines whether a predetermined period has elapsed or not. When the predetermined period has elapsed, the CPU obtains a next page and executes next data delivery.

This application is based on Japanese Patent Application No. 2008-319829 filed with the Japan Patent Office on Dec. 16, 2008, the entire content of which is hereby incorporated by reference.

### BACKGROUND OF THE INVENTION

1. Field of the Invention

The present invention relates to a data delivery system, data delivery device, data delivery method and data delivery program. Particularly, the present invention relates to a data delivery system that includes information processing devices such as terminal devices and a data delivery device connected to them, and also relates to the data delivery device, a data delivery method and a data delivery program that are executed by the data delivery device.

2. Description of the Related Art

There have been proposed various systems that store data in a memory and reads out the data stored in the memory for displaying it by a display device.

For example, Japanese Laid-Open Patent Publication No. 09-160699 has proposed a system that reads an electronic newspaper stored in a memory of an electric newspaper browsing device and displays it by a display device.

Also, Japanese Laid-Open Patent Publication Nos. 2002-118738 and 2006-243581 have disclosed systems that read and transfer data stored in a memory for displaying it by a display device.

Further, Japanese Laid-Open Patent Publication No. 2000-092217 has proposed an electronic conference system that delivers electronic data not to a single device but to a plurality of information processing devices so that a plurality of users can browse the same information for having a conference.

These systems such as the electronic conference system are configured such that electronic data is concurrently delivered to all the information processing devices and each information processing device receives and displays the data. Therefore, even when a user wants to write a comment, memo or the like on screen contents displayed by the information processing device, next electronic data may be delivered, in which case next screen contents are displayed so that the user cannot have a sufficient time for writing the comment, memo or the like.

Therefore, the user must write the comment or the like on paper or the like for executing write input later, or the user must execute the write input independently of the system to prevent an influence on progression of the conference.

### SUMMARY OF THE INVENTION

The invention has been made for overcoming the above problem, and it is an object of the invention to provide a data delivery system including a plurality of information processing devices and a data delivery device connected thereto, and particularly to provide a data delivery system, data delivery device, data delivery method and data delivery program allowing data delivery that is convenient for users.

A data delivery system according to an aspect of the invention includes a plurality of information processing devices; and a data delivery device for delivering a data file including a plurality of pages to the plurality of information processing devices. Each of the information processing devices includes a display, a first controller for receiving the data file of the plurality of pages delivered from the data delivery device and displaying the data on the display. The first controller transmits, according to an operation instruction, a delivery stop command instructing the delivery device to stop the delivery of each of the plurality of pages. The data delivery device includes a memory for storing the data file of the plurality of pages, and a second controller for performing processing of concurrently delivering successively the plurality of pages to the plurality of information processing devices. The second controller is configured to receive the delivery stop command transmitted from the information processing device, and to stop delivery of each of the plurality of pages to at least the information processing device having transmitted the delivery stop command among the plurality of information processing devices.

A data delivery device according to the invention is the data delivery device for delivering a data file including a plurality of pages to a plurality of information processing devices, and includes a memory for storing the data file of the plurality of pages, and a controller for performing processing of concurrently delivering successively the plurality of pages to the plurality of information processing devices. The controller is configured to receive a delivery stop command transmitted from the information processing device, and to stop delivery of each of the plurality of pages to at least the information processing device having transmitted the delivery stop command among the plurality of information processing devices.

Preferably, the delivery stop command includes an all-delivery stop command, or a single-delivery stop command. When the controller receives the all-delivery stop command, the controller stops the delivery of each of the plurality of pages to all the plurality of information processing devices. When the controller receives the single-delivery stop command, the controller stops the delivery of each of the plurality of pages to at least the information processing device having transmitted the single-delivery stop command among the plurality of information processing devices.

Particularly, when the controller receives the all-delivery stop command, the controller transmits delivery stop information indicating that the delivery of each of the plurality of pages to all the information processing devices has stopped to the plurality of information processing devices.

Particularly, when the controller receives an all-delivery resume command instructing resuming of the delivery of each of the plurality of pages to all the plurality of information processing devices, the controller resumes the delivery of each of the plurality of pages to all the plurality of information processing devices. When the controller receives a single-delivery resume command instructing resuming of the delivery of each of the plurality of pages to at least the information processing device having transmitted the single-delivery resume command among said plurality of information processing devices, the controller resumes the delivery of each of the plurality of pages to at least the information processing device having transmitted the single-delivery resume command among the plurality of information processing devices.

Preferably, the memory further stores delivery flags corresponding to the plurality of information processing devices, respectively, for determining from the flag whether the delivery of each of the plurality of pages to the corresponding information processing device is permitted or rejected. When said controller receives the delivery stop command transmitted from the information processing device, the controller sets the corresponding delivery flag stored in said memory to rejection. The controller successively delivers each of the plurality of pages to the plurality of information processing devices according to the delivery flags in the memory.

Particularly, the controller stops the delivery of each of the plurality of pages to all the plurality of information processing devices when the number of the delivery flags stored in the memory and indicating the rejection of the delivery is equal to or larger than a predetermined value.

Particularly, when the controller receives a delivery resume command transmitted from the information processing device and instructing resuming of the delivery of the data, the controller sets the corresponding flag stored in the memory to permission. The controller resumes the delivery of each of the plurality of pages to all the plurality of information processing devices when the number of the delivery flags stored in the memory and indicating the rejection of the delivery is smaller than a predetermined value.

Preferably, the memory further has a plurality of regions arranged corresponding to the plurality of information processing devices for storing the information provided from the corresponding information processing devices, respectively. When the controller receives the delivery resume command and receives composite data prepared by performing write input to each of the plurality of pages transmitted from the information processing device, the controller stores the composite data in the corresponding area among the plurality of regions.

Particularly, at least one page in the data file including the plurality of pages is a predetermined page. The controller is configured to receive each of the composite data corresponding to the predetermined page from said plurality of information processing devices, store each of the composite data in the corresponding region among said plurality of regions, extract each composite data corresponding to the predetermined page stored in each of said regions, and produce one data file including extracted each composite data.

A data delivery device according to another aspect of the invention is a data delivery device for delivering a data file including a plurality of pages to a plurality of information processing devices, and includes a memory for storing the data file of said plurality of pages, and a controller for performing processing of concurrently delivering the data file in the memory to the plurality of information processing devices, and transmitting information of the page to be displayed. The controller is configured to receive a delivery stop command transmitted from the information processing device, and to stop transmission of the information of the page to be displayed to at least the information processing device having transmitted the delivery stop command among the plurality of information processing devices.

A data delivery method according to an aspect of the invention is a data delivery method of delivering a data file including a plurality of pages to a plurality of information processing devices, and includes the steps of concurrently delivering successively the plurality of pages to said plurality of information processing devices; receiving a delivery stop command transmitted from the information processing device; and stopping delivery of each of the plurality of pages to at least the information processing device having transmitted the delivery stop command among the plurality of information processing devices.

A recording medium according to an aspect of the invention is a recording medium storing a data delivery program to be executed by a computer of a data delivery device connected to a plurality of information processing devices and storing a data file including a plurality of pages. The data delivery program causes the computer to execute the steps of concurrently delivering successively the plurality of pages to said plurality of information processing devices; receiving a delivery stop command transmitted from the information processing device; and stopping delivery of each of the plurality of pages to at least the information processing device having transmitted the delivery stop command among the plurality of information processing devices.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 illustrates a relationship of a conference system according to a first embodiment of the invention.

FIG. 2 illustrates data delivery of the conference system according to the first embodiment of the invention.

FIG. 3 is a schematic block diagram of an MFP according to the first embodiment of the invention.

FIG. 4 is a schematic block diagram illustrating a structure of a terminal device that is an information processing device according to the first embodiment of the invention.

FIG. 5 is a flowchart illustrating an activation of a conference system application in the information processing device according to the first embodiment of the invention.

FIG. 6 illustrates an example of an authentication screen according to the first embodiment of the invention.

FIG. 7 illustrates an initial screen of a viewer displayed on a display of the information processing device according to the first embodiment of the invention.

FIG. 8 illustrates a box select screen exhibited when a box button is selected.

FIG. 9 illustrates a conference file select screen exhibited when a conference box button is pushed in FIG. 8.

FIG. 10 illustrates a conference file processing select screen.

FIG. 11 is a flowchart illustrating activation of a box delivery processing in the MFP according to the first embodiment of the invention.

FIG. 12 illustrates a management table prepared according to the first embodiment of the invention.

FIG. 13 is a flowchart illustrating a box delivery processing according to the first embodiment of the invention.

FIG. 14 is a flowchart illustrating control processing on a terminal device side according to the first embodiment of the invention.

FIG. 15 illustrates a display screen displaying the delivery data on a viewer displayed by the display of the information processing device according to the first embodiment.

FIG. 16 illustrates a display screen displaying the delivery data on the viewer displayed by the display of the information processing device according to the first embodiment of the invention.

FIG. 17 is a flowchart illustrating single-delivery stop processing according to the first embodiment of the invention.

FIG. 18 is a flowchart illustrating the single-delivery resume processing according to the first embodiment of the invention.

FIG. 19 is a flowchart illustrating all-delivery stop processing and all-delivery resume processing according to the first embodiment of the invention.

FIGS. 20A and 20B illustrate display screens displaying the delivery data on the viewer displayed by the display of the information processing device according to the first embodiment of the invention.

FIG. 21 is a flowchart illustrating BOX delivery processing according to a second embodiment of the invention.

FIG. 22 is a flowchart illustrating control processing on a terminal device side according to the second embodiment of the invention.

FIG. 23 is a flowchart illustrating BOX delivery processing according to a third embodiment of the invention.

FIG. 24 is a flowchart illustrating all-delivery stop/resume processing according to the third embodiment of the invention.

FIG. 25 is a flowchart illustrating BOX delivery processing according to a fourth embodiment of the invention.

FIG. 26 illustrates preparation of composite file data in the case where data, e.g., about a questionnaire or the like is in predetermined pages.

### DESCRIPTION OF THE PREFERRED EMBODIMENTS

A first embodiment of the invention will be described below with reference to the drawings. In the following description, the same portions and components bear the same reference numbers and the same names, and achieve the same functions.

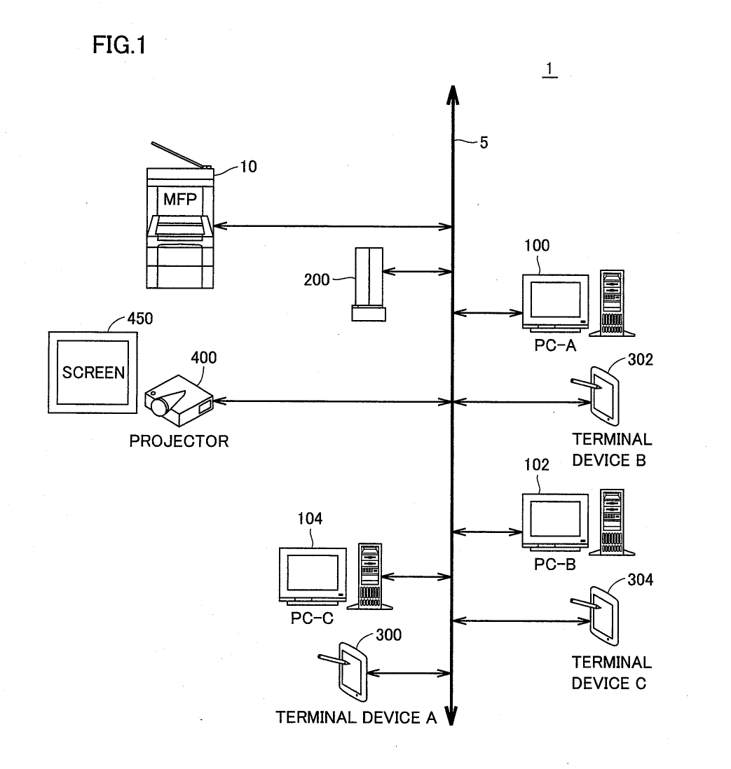

Referring to FIG. 1, description will now be given on a conference system (data delivery system) according to a first embodiment of the invention.

Referring to FIG. 1, a conference system 1 according to the first embodiment of the invention includes an MFP (Multi Function Peripheral) 10, a server 200, personal computers (which may be simply referred to as “PCs” hereinafter) 100, 102 and 104 which are information processing devices, and portable terminal devices (which may be simply referred to as “terminal devices” hereinafter) 300, 302 and 304. These are connected together over a LAN (Local Area Network) 5 to allow mutual data transmission. A projector 400 is connected to LAN 5, and can project the delivery data transmitted to projector 400 on a screen 450. For discriminating PCs 100, 102 and 104 from each other, these may be represented as “PC-A”, “PC-B” and “PC-C”, respectively. For discriminating portable terminal devices 300, 302 and 304 from each other, these may be represented as “terminal device A”, “terminal device B” and “terminal device C”, respectively. In the example described below, each terminal is connected to LAN 5. However, it may be connected to a WAN (Wide Area Network), Public Switched Telephone Network (PSTN), Internet or the like other than the LAN. The connection may be wire communication or wireless communication. Although three PCs, i.e., PC-A, PC-B and PC-C as well as three terminal devices A, B and C are shown as the information processing devices, the numbers of them are not restrictive, and the invention may have any configuration that includes a plurality of information processing devices.

In conference system 1 of the invention, MFP 10 stores the delivery data to be delivered to the information processing devices, i.e., the PCs, terminal devices and the like, and executes the data delivery over LAN 5. Thus, MFP 10 is a data delivery device.

Server 200 executes the authentication processing with respect to the information processing devices, i.e., the PCs, terminal devices and the like. Server 200 will be referred to as an “authentication server” hereinafter. Authentication server 200 has prestored user's IDs, passwords and the like of users that use the conference system of the invention, executes the authentication processing based on the user's ID and password transmitted from the information processing device and determines whether the authentication succeeds or not. When the authentication succeeds, i.e., when the user's ID and password transmitted form the information processing device match the prestored user's ID and password, respectively, authentication server 200 determines that the authentication succeeds, and transmits a result of the authentication to the information processing device that transmitted the user's IS and password. As will be described later, the user information corresponding to the successful authentication is transmitted in response to the inquiry from MFP 10.

Each of the information processing devices, i.e., PC-A, PC-B, PC-C and terminal devices A, B and C has stored a software program that can display the delivery data delivered from MFP 10 on its display. When a CPU (Central Processing Unit) of each information processing device executes the software program, the user can browse the delivery data received by the display of the device. As will be described layer, it is configured such that the user can execute write input on the delivery data that is displayed on the display and is being browsed.

Projector 400 projects the delivery data delivered from MFP 10 onto screen 450.

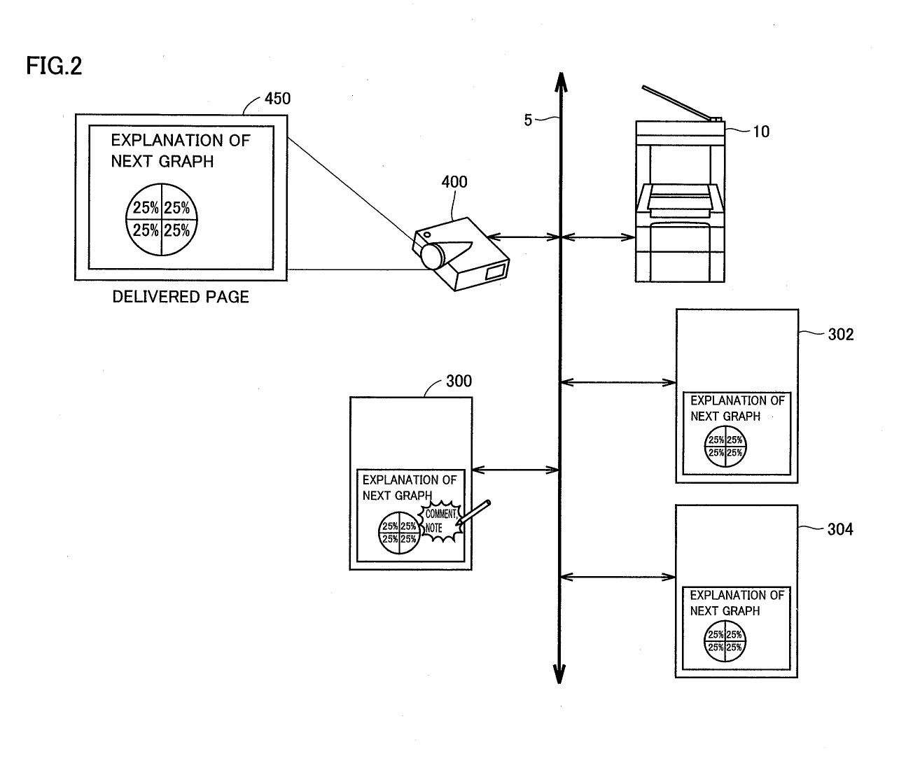

Referring to FIG. 2, description will be given on the data delivery of the conference system according to the first embodiment of the invention.

Referring to FIG. 2, MFP 10 delivers the stored delivery data to all of projector 400 and the information processing devices over LAN 5. Projector 400 projects the delivery data onto screen 450, and terminal devices (A, B and C) 300, 302 and 304 that are the information processing devices, respectively, display the same delivery data. The system is configured such that the information processing device can execute the write input on the delivered delivery data. Also, the system is configured such that each information processing device can perform the write input when the delivery of the delivery data to be described later is at rest. In an example of the embodiment described below, a comment or note is added to the delivered data in terminal device 300. Although only terminal devices 300, 302 and 304 are shown in the figures, the same is true with respect to PC-A, PC-B and PC-C.

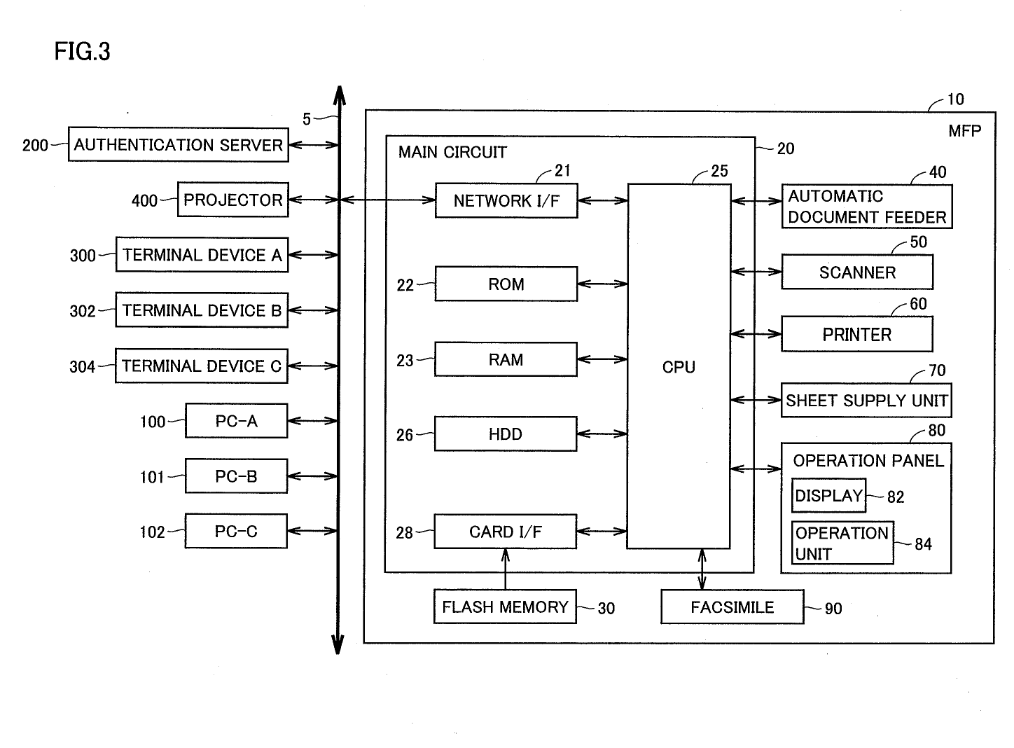

Referring to FIG. 3, description will be given on a schematic block diagram of MFP 10 according to the first embodiment of the invention.

Referring to FIG. 3, MFP 10 according to the first embodiment of the invention includes a main circuit 20, an automatic document feeder 40, a scanner 50, a printer 60, a sheet supply unit 70, an operation panel 80 and a facsimile 90.

Main circuit 20 includes a Central Processing Unit (CPU) 25, a network interface (I/F) unit 21 for executing data transfer to/from LAN 5, a ROM (Read Only Memory) 22 storing various software programs for executing predetermined functions in MFP 10, a RAM (Random Access Memory) 23 used as a work area and others of CPU 25, an HDD (Hard Disk Drive) 26 used as a large-capacity storage device, and a card interface (I/F) 28 that is connected to a flash memory 30, i.e., an external storage device for executing data transfer to/from memory 30. CPU 25 is connected to each of network I/F 21, ROM 22, RAM 23, HDD 26 and card I/F 28, and controls whole main circuit 20. The conference system in this embodiment is configured such that HDD 26 has prestored the delivery data delivered in the system.

Automatic document feeder 40 feeds the documents laid on a document table (not shown) of the MFP to scanner 50 one by one.

Scanner 50 optically reads image information such as photographs, letters, pictures and the like from the document fed from automatic document feeder 40, and thereby obtains image data.

Printer 60 forms color images with toners of four colors of cyan, magenta, yellow and black. It may form a monochrome image with the toner of one color of cyan, magenta, yellow or black.

Sheet supply unit 70 has stored paper sheets, and supplies the stored sheets to printer 60 one by one.

Operation panel 80 includes a display 82 and an operation unit 84.

Display 82 is a display such as a Liquid-Crystal Display (LCD), an organic ELD (Electro Luminescence Display) or the like, and displays an instruction menu for the user, information about obtained image data and the like. Operation unit 84 includes a plurality of keys, and accepts input of data such as various instructions, letters, numbers and the like entered by the key operation of the user. Operation unit 84 includes a touch panel arranged on display 82. Display 82 and operation unit 84 form operation panel 80. Although not shown, operation unit 84 in the example has box buttons that allow access to the data stored in HDD 26.

Facsimile 90 is connected to the Public Switched Telephone Network (PSTN) for transmitting facsimile data. Also, it receives facsimile data from the PSTN. CPU 25 stores the facsimile data received by facsimile 90 in HDD 26. Printer 60 prints the facsimile data stored in HDD 26 on paper sheets according to the instruction of CPU 25.

CPU 25 is connected to automatic document feeder 40, scanner 50, printer 60, sheet supply unit 70, operation panel 80 and facsimile 90 for controlling whole MFP 10.

Description will now be given on the processing of delivering data (delivery data) stored in HDD 26 from MFP 10 to projector 400 and the information processing devices through network I/F 21 and LAN 5.

Referring to FIG. 4, description will be given on a schematic block diagram illustrating a structure of terminal device 100 that is the information processing device according to the first embodiment of the invention.

This embodiment will be described, by way of example, in connection with terminal device 100, and terminal devices 102 and 104 have substantially the same structure. Information processing devices 300, 302 and 304 have substantially the same structure. For the sake of simplicity, the following description will be given on the case where the terminal device is operated.

Referring to FIG. 4, terminal device 100 includes a CPU 111 controlling whole terminal device 100, an input device 109, a display 105 that is a Liquid-Crystal Display (LCD), an organic ELD (Electro Luminescence Display) or the like, a communication interface 107 for externally transmitting and receiving the data over LAN 5, a memory 113 including a RAM used as a work area and a ROM storing software programs to be executed by CPU 111, an HDD 115 serving as a large-capacity storage device, and an internal bus 103 connected these devices and units.

In this example, CPU 111 is configured to execute the predetermined software application which is stored in the ROM of memory 113 (and may also be referred to as a “conference system application”) so that display 105 displays the viewer for displaying the delivery data in the conference system (data delivery system) after the authentication processing.

When display 105 displays the viewer, the received delivery data delivered from MFP 10 is displayed on the viewer in terminal device 100. It is configured such that the user can execute the write input by input device 109 on the delivery data displayed on the viewer.

For example, input device 109 has a touch panel and a touch pen, and is configured to provide a key input screen (not shown) that accepts data input of various instructions, letters, numbers or the like in response to the key operation of the user's with the touch pen. In addition to the above key input screen, it is configured such that the write input of the comment or note already described with reference to FIG. 2 can be directly executed on the delivery data displayed on the viewer. Without employing the touch panel, the write input may be executed with an input device such as a keyboard provided with a plurality of keys or a mouse.

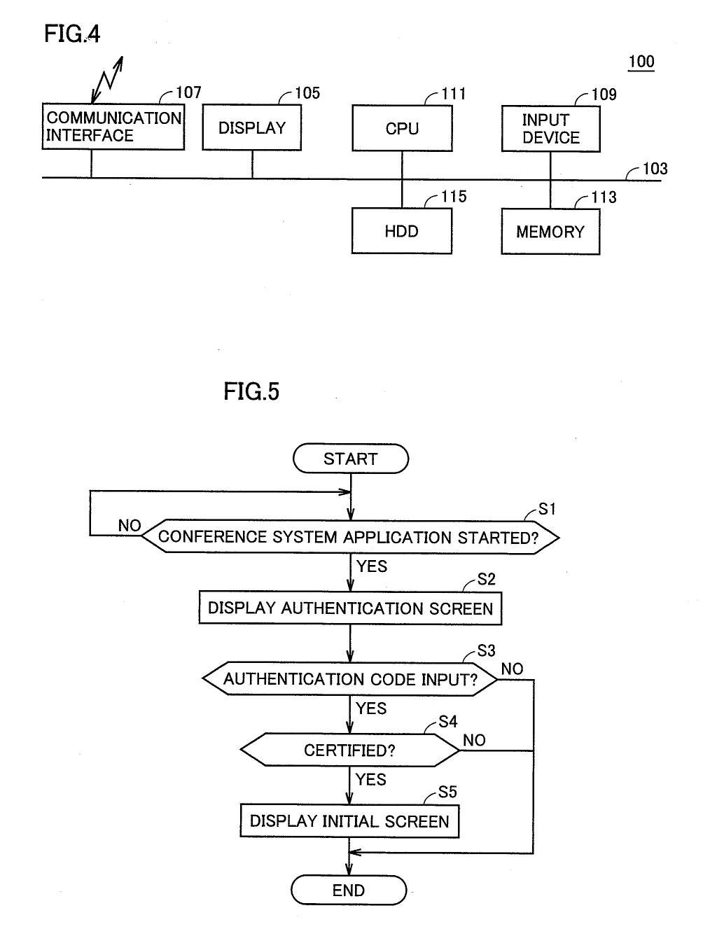

Referring to FIG. 5, description will be given on an activation of the conference system application in the information processing device according to the first embodiment of the invention. The processing in this flowchart is implemented when CPU 111 of terminal device 100 executes the predetermined program stored in the ROM.

Referring to FIG. 5, it is first determined whether the conference system application started or not (step S1). Specifically, it is determined whether the user instructed the start-up or activation by accessing the conference system application stored in the ROM or not.

When the conference system application started in step S1, an authentication screen is displayed (step S2).

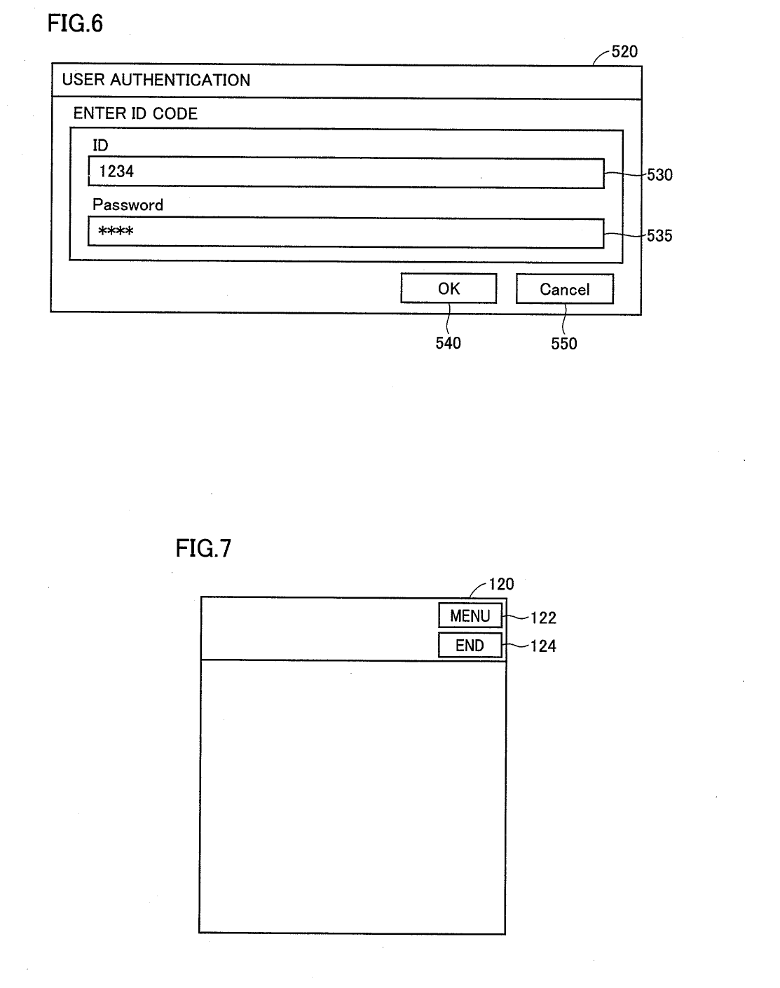

Referring to FIG. 6, description will be given on an example of the authentication screen according to the first embodiment of the invention.

Referring to FIG. 6, an authentication screen 520 according to the first embodiment of the invention exhibits a screen for entering an authentication code by the user.

Specifically, there are arranged an input field 530 for entering a user ID (Identification) that is an authentication code, and an input field 535 for entering a password.

The user enters the user ID and password in input fields 530 and 535 through the plurality of keys arranged as input device 109, respectively.

When the user pushes an “OK” button 540, the entered user's ID and password are transmitted to authentication server 200 through communication interface 107. In this example of the embodiment, characters “1234” are displayed in input field 530 of the user's ID, and symbols “*” are displayed in password input field 535 for security.

When a “Cancel” button 550 is pushed, the authentication processing ends. In this case, start-up of the conference system application ceases.

Referring to FIG. 5 again, it is determined whether the authentication code is entered or not (step S3). Specifically, it is determined in FIG. 6 whether the user entered the user ID, i.e., the authentication code and the password and pushed “OK” button 540, or not.

Then, it is determined whether the code is certified or not (step S4). Specifically, authentication server 200 executes the authentication processing based on the transmitted authentication code, and it is determined whether the authentication result that the authentication transmitted from authentication server 200 is successful is received or not.

When the authentication result that the authentication transmitted from authentication server 200 is successful is received in step S4, i.e., when the code is certified, the initial screen is then displayed (step S5).

Then, the start processing ends (END).

Referring to FIG. 7, description will be given on an initial screen 120 of the viewer displayed on display 105 of the information processing device according to the first embodiment of the invention.

Referring to FIG. 7, a state in which no delivery data is delivered is shown.

A menu button 122 and an end button 124 are arranged on initial screen 120 of the viewer.

For example, when the user selects menu button 122, the user can execute various settings of the information processing device in the conference system.

For example, when the user selects end button 124, the user can end the conference system application.

In a configuration of this example, the touch panel is arranged as the input device so that the button can be selected by touching the button with a touch pen.

Then, description will be given on the delivery processing in MFP 10.

As described above, HDD 26 of MFP 10 in this example is configured to store the delivery data in the conference system according to the first embodiment of the invention.

As described above, operation unit 84 is provided with a box button that allows access to HDD 26. When this box button is selected, a select screen or the like for accessing the data stored in HDD 26 is displayed.

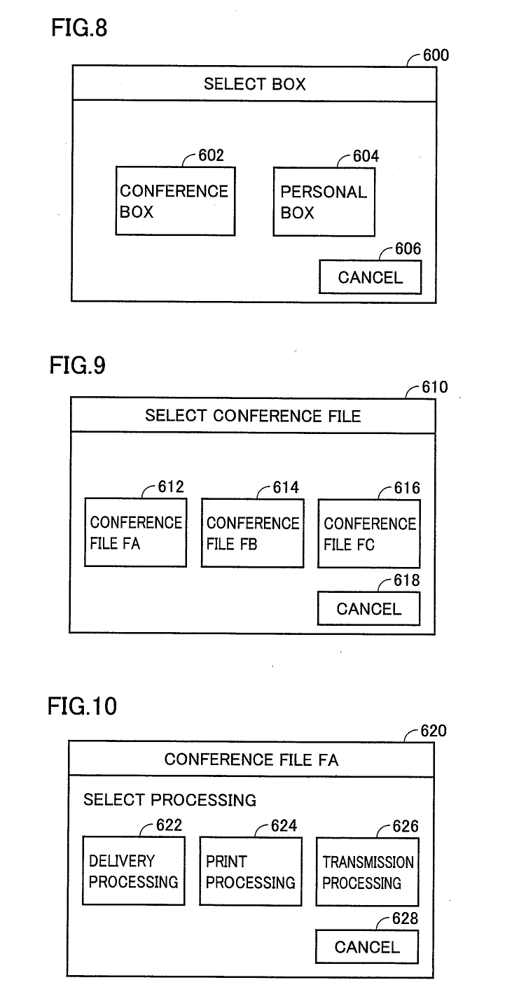

Referring to FIG. 8, description will be given on a BOX select screen exhibited when the box button is selected.

Referring to FIG. 8, BOX select screen 600 is provided with a conference box button 602 and an personal box button 604 which are prearranged for allowing access to a conference BOX and a personal BOX, respectively. By selecting a cancel button 606, the BOX select screen ends and the screen returns to the initial screen.

By selecting conference box button 602, the user can access the conference BOX data stored in HDD 26. By selecting personal box button 604, the user can access the personal BOX data. In this example, operation unit 84 includes a touch panel arranged on display 82 so that a user can perform selection by touching the button with a finger. The user can use a touch pen or the like instead of the finger. This is true with respect to the following description.

The personal BOX has predetermined storage regions corresponding to the user names, respectively. For example, the personal BOX is provided with predetermined storage regions corresponding to user names “AAA”, “BBB”, “CCC”, “DDD”, “EEE” and “FFF”, respectively, as will be described later. The conference BOX and the personal BOX are formed of predetermined storage regions in HDD 26, respectively.

Referring to FIG. 9, description will be given on a conference file select screen exhibited when the conference BOX button is pushed in FIG. 8.

In the example of the embodiment shown in FIG. 9, conference files FA, FB and FC are in a selectable state on a conference file select screen 610. Specifically, there are arranged a conference file FA select button 612, a conference file FB select button 614 and a conference file FC select button 616. By selecting a cancel button 618, the conference file select screen ends, and the screen returns to the initial screen.

On conference file select screen 610, the user selects conference file FA select button 612, conference file FB select button 614 or conference file FC select button 616 so that the next conference file processing select screen is displayed.

Referring to FIG. 10, description will be given on the conference file processing select screen.

In this embodiment shown in FIG. 10, a conference file processing select screen 620 is provided with select buttons for selecting the processing relating to conference file FA. Specifically, FIG. 10 shows a state in which a delivery processing button 622, a print processing button 624 and a transmission processing button 626 are selectable. By selecting delivery processing button 622, an instruction is issued to execute the data delivery processing for conference file FA. By selecting print processing button 624, an instruction is issued to execute the print processing for conference file FA. By selecting transmission processing button 626, an instruction is issued to execute the transmission processing for conference file FA. By selecting a cancel button 628, the conference file processing select screen ends, and the screen returns to the initial screen.

This embodiment will now be described in connection with the case where the user select delivery processing button 622 to instruct the execution of the data delivery processing of the data stored in the BOX (which may also be referred to as “BOX delivery processing” hereinafter). By way of example, the BOX delivery processing of conference file FA will be described below. Conference file FA is file data formed of a plurality of pages.

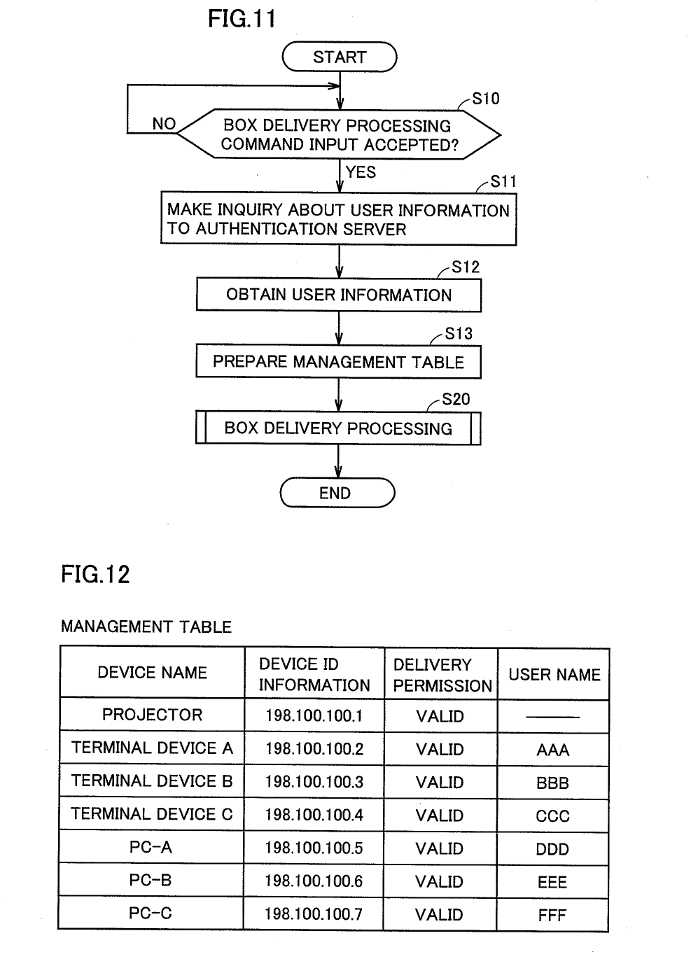

Referring to FIG. 11, description will be given in connection with a flowchart illustrating activation of the BOX delivery processing in MFP 10 according to the first embodiment of the invention. The processing illustrated in this flowchart is implemented by executing a predetermined program stored in ROM 22 by CPU 25 of MFP 10. This is also true with respect to flowcharts executed by MFP 10.

Referring to FIG. 11, CPU 25 first determines whether the input of the BOX delivery processing command is accepted or not (step S10). Specifically, it determines, e.g., whether the user pushed delivery processing button 622 on conference file processing select screen 610 illustrated in FIG. 10 or not.

Then, CPU 25 makes an inquiry about the user information to authentication server 200 (step S11). Specifically, it makes an inquiry through network I/F 21 to authentication server 200 about the information of the certified user. The user information is configured to include a name of the certified user, a name of a device used by the user, device identification information, i.e., an IP (Internet Protocol) address of the device and others.

CPU 25 obtains the user information from authentication server 200 (step S12). When the conference system application starts as described above, the authentication processing is executed with respect to authentication server 200. Therefore, by making an inquiry about the information of the certified user, it is possible to grasp or determine the device in which the conference system application has started to display the initial screen, i.e., the device that allows the delivery of the delivery data.

Then, CPU 25 prepares a management table based on the obtained user information and the like (step S13).

Referring to FIG. 12, description will be given on the management table prepared according to the first embodiment of the invention.

In the example shown in FIG. 12, the management table includes items of “device name” that is a destination of the BOX delivery processing, “device identification information” that is an IP (Internet Protocol) address, a “delivery permission” flag for determination whether the delivery is permitted or not, and “user name”.

CPU 25 prepares a management table by registering data of these items based on the user information that is obtained in response to the inquiry to authentication server 200.

It is assumed that the delivery permission flag is initially set valid.

In an example of the embodiment, the projector, terminal devices A, B and C, and PC-A, PC-B and PC-C are registered as items of the “device name”, respectively. “198.100.100.1”-“198.100.100.7” are registered as the IP addresses, i.e., the items of the device identification information, respectively. All the delivery permission flags are valid. “AAA”, “BBB”, “CCC”, “DDD”, “EEE” and “FFF” are registered as the names of users using the information processing devices, respectively.

An administrator has registered in advance the device information about the projector in HDD 26. CPU 25 prepares the management table by obtaining the user information as well as the device information about the projector registered in HDD 26.

Referring to FIG. 11 again, the BOX delivery processing is then executed (step S20).

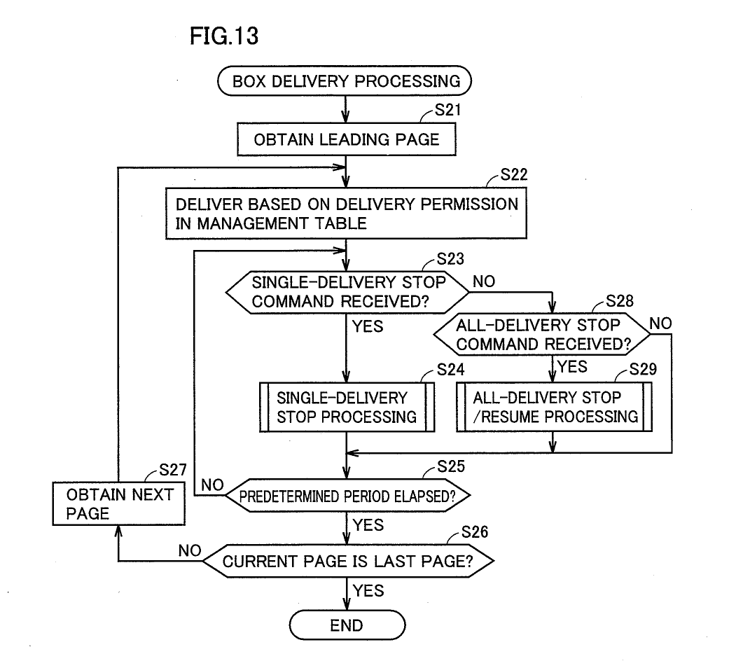

Referring to FIG. 13, description will be given on the BOX delivery processing according to the first embodiment of the invention.

Referring to FIG. 13, a first page is first obtained (step S21).

Specifically, CPU 25 reads data of selected conference file FA from HDD 26, and particularly reads data in a first page among the plurality of pages constituting selected conference file FA.

Then, CPU 25 executes the delivery based on the delivery permission flag in the management table to be described later (step S22). Specifically, CPU 25 delivers, as the delivery data, the data in the read first page through network I/F 21 based on a predetermined destination (device identification information) registered in the management table.

Then, CPU 25 determines whether a single-delivery stop command is received through network I/F 21 or not (step S23).

When CPU 25 determines in step S23 that the single-delivery stop command is received, the single-delivery stop processing is executed (step S24). The single-delivery stop processing will be described later.

In step S23, when CPU 25 does not receive the single-delivery stop command, it determines whether an all-delivery stop command is received or not (step S28). In step S28, when CPU receives the all-delivery stop command, it executes all-delivery stop/resume processing (step S29). The all-delivery stop/resume processing will be described later.

In step S28, when CPU 25 does not receive the all-delivery stop processing command, the process proceeds to step S25 and CPU 25 determines whether a predetermined period has elapsed or not (step S25).

In step S25, CPU 25 determines whether a predetermined period has elapsed or not. When it has not elapsed, the process returns to step S23 for repeating the above processing.

When CPU 25 determines in step S25 that the predetermined period has elapsed, it determines whether the current page is the last page or not (step S26).

When CPU 25 determines in step S26 that the current page is not the last page, the process proceeds to step S27 for obtaining the next page. Specifically, CPU 25 reads data of the next page from HDD 26. Then, the process returns to step S22, and the delivery of the next page is executed. The above processing is repeated. When the current page is the last page in step S26, the BOX delivery processing ends (END).

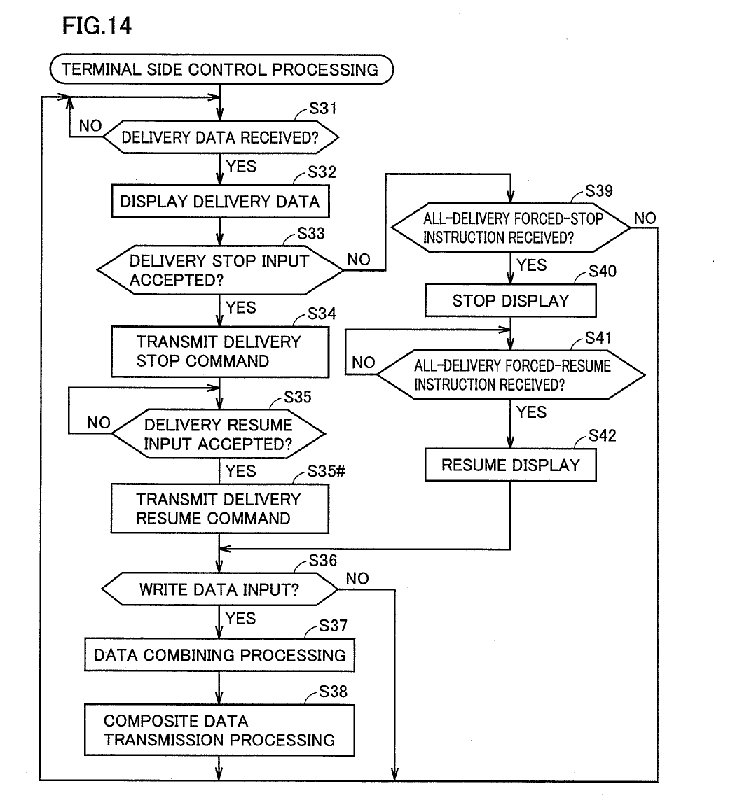

Referring to FIG. 14, description will be given on control processing on a terminal device side (i.e., terminal-side control processing) according to the first embodiment of the invention. Although the control processing for the terminal device will be described below, the same is true with respect to the control processing on the PC side. In terminal device 100, the conference system application has started to display the initial screen. The processing illustrated in the flowchart is implemented when CPU 111 in terminal device 100 executes a predetermined program stored in the ROM. This is also true with respect to the flowcharts of the processing executed by terminal device 100.

Referring to FIG. 14, it is first determined whether the delivery data is received or not (step S31). Specifically, CPU 111 in terminal device 100 determines whether it receives the delivery data through communication interface 107.

When CPU 111 receives the delivery data, it displays the received delivery data on the viewer (step S32).

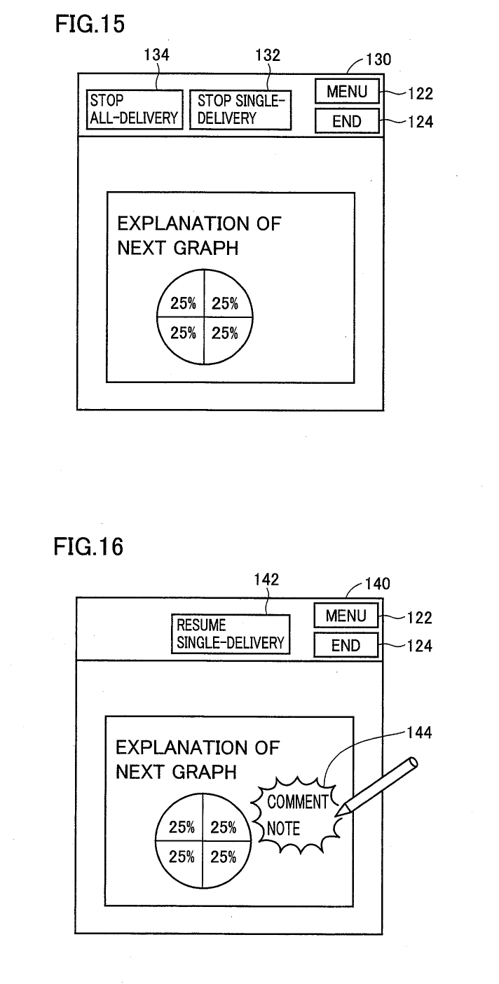

Referring to FIG. 15, description will be given on a display screen 130 displaying the delivery data on the viewer displayed by display 105 of the information processing device according to the first embodiment.

FIG. 15 shows a state in which the delivery data is displayed.

FIG. 15 shows the case where menu button 122 and end button 124 as well as an all-delivery stop button 134 and a single-delivery stop button 132 are arranged.

By selecting all-delivery stop button 134, the all-delivery stop command is transmitted to MFP 10 through communication interface 107. By selecting single-delivery stop button 132, the single-delivery stop command is transmitted to MFP 10 through communication interface 107.

Referring to FIG. 14 again, it is then determined whether the delivery stop input is accepted or not (step S33). Specifically, it is determined on display screen 130 in FIG. 15 whether the all-delivery stop button or single-delivery stop button is selected or not.

In step S33, when CPU 111 accepts the input of the delivery stop, it transmits the delivery stop command (step S34).

Specifically, when user pushes all-delivery stop button 134, CPU 111 transmits the all-delivery stop command to MFP 10. When the user pushes single-delivery stop button 132, CPU 111 transmits the single-delivery stop command to MFP 10.

Then, CPU 111 determines whether it accepts the delivery resume input or not (step S35). The device is configured such that all-delivery stop button 134 changes into the all-delivery resume button when all-delivery stop button 134 is selected at this point in time. Also, it is configured such that single-delivery stop button 132 changes into the single-delivery resume button when single-delivery stop button 132 is selected. CPU 111 determines whether the delivery resume input is accepted or not, i.e., whether the all- or single-delivery resume button is selected or not.

Referring to FIG. 16, description will be given on a display screen 140 displaying the delivery data on the viewer displayed by display 105 of the information processing device according to the first embodiment of the invention.

FIG. 16 shows the case where the delivery data is displayed and single-delivery stop button 132 was selected so that single-delivery stop button 132 has changed to a single-delivery resume button 142. FIG. 16 also shows the state where single-delivery stop button 132 was selected, the delivery of the delivery data to the device in question has stopped, and further input of write data 144 such as a comment, note or the like is performed on the delivery data. All-delivery stop button 134 is not displayed and cannot be selected because the single-delivery stop button is selected. An example of the embodiment has been described in connection with the case where all-delivery stop button 134 is not displayed. Naturally, the button may be configured such that it is displayed but cannot be selected.

The case where single-delivery stop button 132 is selected has been described. However, the same is true with respect to the case where all-delivery stop button 134 is selected. The device is configured such that when all-delivery stop button 134 is selected, all-delivery stop button 134 changes into the all-delivery resume button, and single-delivery stop button 132 is not displayed, or is displayed without allowing selection.

As described later, when single-delivery resume button 142 is selected, a single-delivery resume command is transmitted to MFP 10, and data combining processing for combining write data 144 and the delivery data together is executed to transmit composite data thus prepared to MFP 10.

Referring to FIG. 14 again, when CPU 111 accepts the delivery resume input, it transmits a delivery resume command (step S35#). Specifically, when the user selects the all-delivery resume button, CPU 111 transmits an all-delivery resume command to MFP 10. When the user selects the single-delivery resume button, CPU 111 transmits the single-delivery resume command to MFP 10. In the example shown in FIG. 16, when single-delivery resume button 142 is selected, the single-delivery resume command is transmitted to MFP 10.

Then, CPU 111 determines whether the write data is input or not (step S36). The device is configured such that when display 105 displays the viewer as described above, the write input can be performed by input device 109 on the delivery data displayed on the viewer. For example, the write input of a comment, note or the like can be executed.

When CPU 111 determines that the write data is input in step S36, the data combining processing is executed for combining the write data and the delivery data (step S37).

Then, the processing of transmitting the composite data prepared by the data combining processing is executed (step S38). Specifically, CPU 111 transmits the composite data to MFP 10 through communication interface 107.

Then, the processing returns to step S31. When the next delivery data is received in step S31, the next delivery data is displayed, and the above processing is repeated.

When CPU 111 determines in step S33 that the input of the delivery stop is not accepted, it determines whether the all-delivery forced-stop command is received or not (step S39). This processing will be described later.

When CPU 111 determines in step S39 that it receives the instruction of the all-delivery forced-stop, CPU 111 executes the display of stop (step S40). Then, CPU 111 determines whether the instruction of the all-delivery forced-resume is received or not (step S41).

When CPU 111 determines in step S41 that the instruction of the all-delivery forced-resume is received, it executes the display of the resume (step S42). Then, the process proceeds to step S36. Subsequent processing is substantially the same as that already described, and therefore description thereof is not repeated.

(Single-Delivery Stop Processing and Single-Delivery Resume Processing)

As described above, when single-delivery stop button 132 is selected in FIG. 15, CPU 25 receives the single-delivery stop command, and executes the single-delivery stop processing in step S24 in FIG. 13.

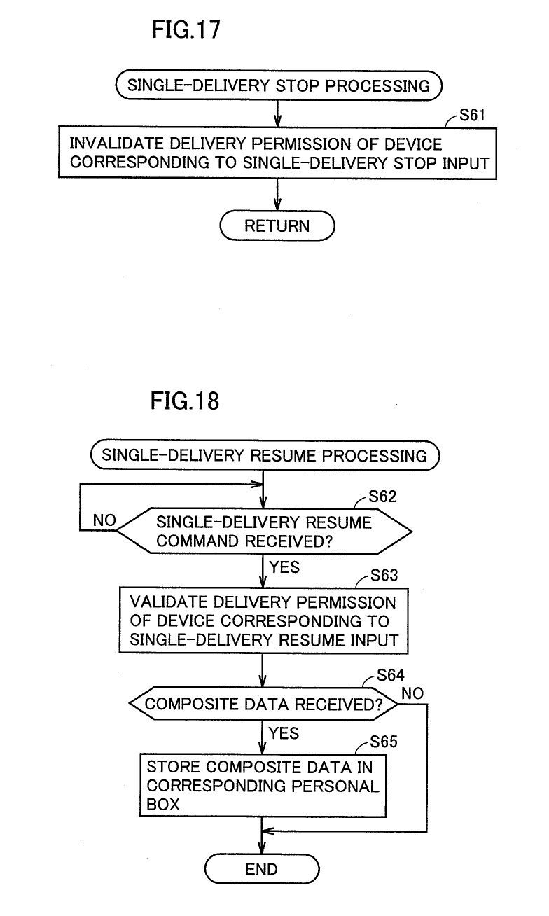

Referring to FIG. 17, description will be given on the single-delivery stop processing according to the first embodiment of the invention.

Referring to FIG. 17, when CPU 25 of MFP 100 receives the single-delivery stop command, it invalidates the delivery permission flag of the device corresponding to the input of the single-delivery stop command in the management table (step S61). For example, when terminal device 300 enters the single-delivery stop command, the “device name” in the management table invalidates the delivery permission flag of terminal device A. Thereby, the delivery permission flag in the management table of the device providing the single-delivery stop command changes from a valid state to an invalid state. In the BOX delivery processing, therefore, when the next page is obtained for delivery, the delivery data is not transmitted to terminal device 300 in question because its delivery permission flag in the management table is invalid, and the delivery data is transmitted to only the other devices corresponding to the valid delivery permission flag.

Referring to FIG. 18, description will be given on the single-delivery resume processing according to the first embodiment of the invention.

The device having selected the single delivery stop command can start the single-delivery resume processing according to arbitrary timing.

Referring to FIG. 18, CPU 25 determines whether it has received the single-delivery resume command or not (step S62).

When CPU 25 receives the single-delivery resume command in step S62, it validates the delivery permission flag of the device corresponding to the input of the single-delivery resume command (step S63). For example, CPU 25 receives the single-delivery resume command from terminal device 300, it validates the delivery permission flag of terminal device A of “device name” in the management table. Thereby, the delivery permission flag in the management table of the device corresponding to the input of the single-delivery resume command changes to the invalid state to the valid state. Therefore, in the box delivery processing of obtaining and delivering the next page, the delivery data is transmitted again to terminal device in question 300 because its delivery permission flag in the management table is valid.

Then, CPU 25 determines whether it has received the composite date or not (step S64). Specifically, when the write input to the delivery data is performed in the terminal device transmitting the single-delivery resume command, the composite data prepared by executing the data combining processing on the delivery data and the write data is transmitted as described before. Therefore, CPU 25 determines whether it has received the composite data in question from the terminal device in question or not.

In step S64, when CPU 25 determines that the composite data is received, it stores the composite data in the corresponding personal BOX (step S65).

Then, the processing ends (END). Thereby, the composite data that the user prepared by executing the write input of the comment, note or the like to the delivery data is stored in the predetermined storage region corresponding to the individual user name of the personal BOX. For example, the composite data thus stored can be accessed by selecting personal box button 604 illustrated in FIG. 8.

(All-Delivery Stop Processing and All-Delivery Resume Processing (Which may be Collectively Referred to as “All-Delivery Stop/Resume Processing” Hereinafter)

As described above, when all-delivery stop button 134 is selected in FIG. 15, the terminal device transmits the all-delivery stop command.

CPU 25 receives the all-delivery stop command, and the all-delivery stop/resume processing is executed in step S29 in FIG. 13.

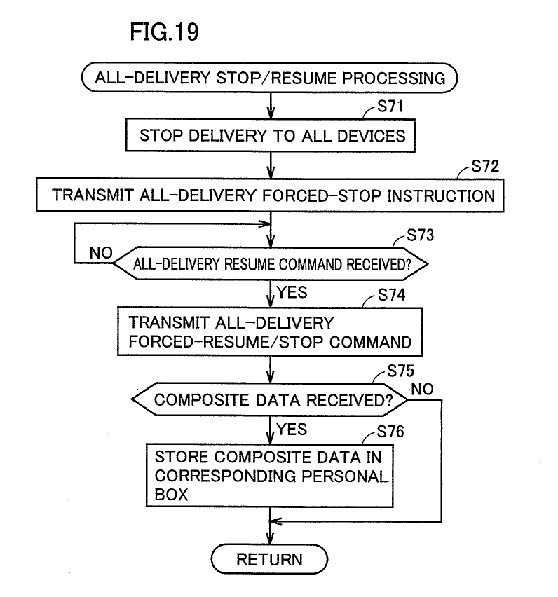

Referring to FIG. 19, description will be given on the all-delivery stop processing and all-delivery resume processing according to the first embodiment of the invention.

Referring to FIG. 19, when CPU 25 of MFP 10 receives the all-delivery stop command, it stops the delivery to all the devices (step S71). For example, when CPU 25 receives the all-delivery stop command from terminal device 300, it stops the delivery processing for all the devices.

Then, CPU 25 transmits the all-delivery forced-stop instruction through network I/F 21 to all the devices of the delivery targets (step S72).

On each device side to which the all-delivery forced-stop instruction is transmitted, each device receives the all-delivery forced-stop instruction in step S39 in FIG. 14, and each device executes the stop display by display 105 in step S40.

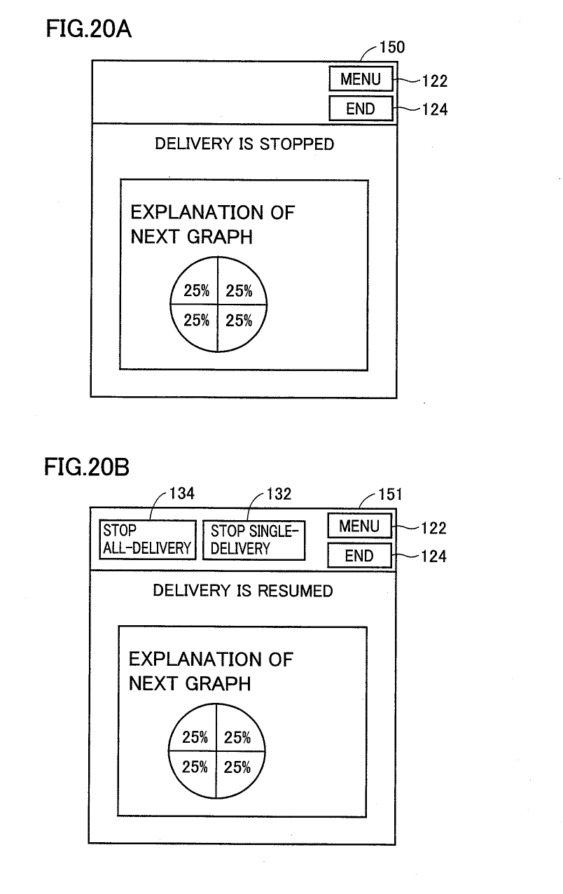

Referring to FIGS. 20A and 20B, description will be given on display screens 150 and 151 displaying the delivery data on the viewer displayed by display 105 of the information processing device according to the first embodiment of the invention.

FIG. 20A shows the case where display screen 150 of display 105 represents, e.g., “delivery is stopped”.

The terminal device is configured such that single-delivery stop button 132 and all-delivery stop button 134 of the terminal device receiving the all-delivery forced-stop instruction are not displayed, or are in the state where the button are displayed but cannot be selected.

From this display, the user can recognize from the display contents displayed on display screen 150 that the all-delivery stop command is transmitted to MFP 10 and the delivery of the delivery data has stopped.

Since the delivery of the delivery data has stopped, the user can execute the write input of the comment, note and the like on the display screen in question as already described.

When all-delivery stop button 134 is selected, e.g., in terminal device 300 as described before, all-delivery stop button 134 of terminal device 300 changes to the all-delivery resume button, similarly to the case already described with reference to FIG. 16. By selecting the all-delivery resume button arranged on terminal device 300, the all-delivery resume command is transmitted to MFP 10.

Referring to FIG. 19 again, it is determined whether the all-delivery resume command is received or not (step S73). When the all-delivery resume command is received in step S73, CPU 25 transmits the all-delivery forced-resume instruction through network I/F 21 to all the devices of the delivery targets (step S74).

Thereby, on each terminal side to which the all-delivery forced-resume instruction is transmitted, it is determined in step S41 in FIG. 14 whether each device has received the all-delivery forced-resume instruction or not. When the device has received the all-delivery forced-resume instruction, the resume display is executed on display 105 of each terminal in step S42.

FIG. 20B shows the case where a display screen 151 of display 105 displays, e.g., “Delivery is resumed”.

From the displayed contents on display screen 151, the user can recognize that the all-delivery resume command is transmitted to MFP 10 and the delivery of the delivery data is resumed.

As described above, when the delivery of the delivery data has stopped, each user can execute the write input of the comment, note or the like on the displayed screen of the device. Therefore, each device executes the processing in steps S36-S38 in FIG. 14. When the write input to the delivery data is performed, each device performs the data combining processing on the delivery data and the write data, and transmits the composite data as described above.

In this operation, the terminal device that receives the all-delivery forced-resume instruction displays single-delivery stop button 132 and all-delivery stop button 134 again, and single-delivery stop button 132 and all-delivery stop button 134 of each terminal device are in the selectable state according to the configuration of this example. Therefore, when the user further intends to stop the delivery after the last stop of the delivery caused by another user, the user can select single-delivery stop button 132 or all-delivery stop button 134, and thereby can execute the above processing in a similar manner.

Referring to FIG. 19 again, CPU 25 determines whether the composite data is received or not (step S75). Specifically, when the write input to the delivery data is performed in each device, the device transmits the composite data prepared by the data combining processing performed on the delivery data and the write data as described above. Therefore, CPU 25 determines whether the composite data is received from each device or not.

When CPU 25 determines in step S75 that the composite data is received, each device stores the composite data in the corresponding personal BOX (step S65). Then, the all-delivery stop/resume processing ends (RETURN). Thereby, the composite data prepared by executing the write input of the comment, note or the like to the delivery data by the user can be stored in a predetermined storage region corresponding to each user name of the personal BOX as described above.

Referring to FIG. 13 again, the all-delivery stop/resume processing ends, the process proceeds to step S25 and it is determined whether the predetermined period has elapsed or not. When the predetermined period has elapsed, the process proceeds to step S26, and the foregoing processing is repeated. Such a manner may be employed that, when the all-delivery stop/resume processing is executed, the processing in step S25 is not executed, and the process proceeds to step S26.

In the method according to the first embodiment of the invention, therefore, the user can select the single-delivery stop command to stop the delivery of the delivery data to be delivered to the his/her own terminal device or the like, and can execute the writing of a comment or note on the screen. Therefore, the method can implement the data delivery system that is convenient for the users. When the user selects the single-delivery stop command, this selection does not stop the delivery of the delivery data to the other terminal devices or the like, and therefore does not affect the progress of the conference.

When it is necessary to stop the progress of the conference, the user can select the all-delivery stop command so that the delivery of the delivery data to all the devices can be easily stopped, and all the users attending the conference can keep pace with each other.

When the user executes the write input to the delivery data in the terminal device or the like while the delivery of the delivery data is stopped, the HDD stores the composite data so that the data delivery system convenient for the users can be implemented.

### Second Embodiment

A second embodiment of the invention will be described below in connection with the case where all the data (file data consisting of a plurality of pages) is transmitted to each information processing device, and MFP 10 successively specifies the pages to be displayed. The structure of each device is substantially the same as that in the first embodiment already described so that detailed description thereof is not repeated.

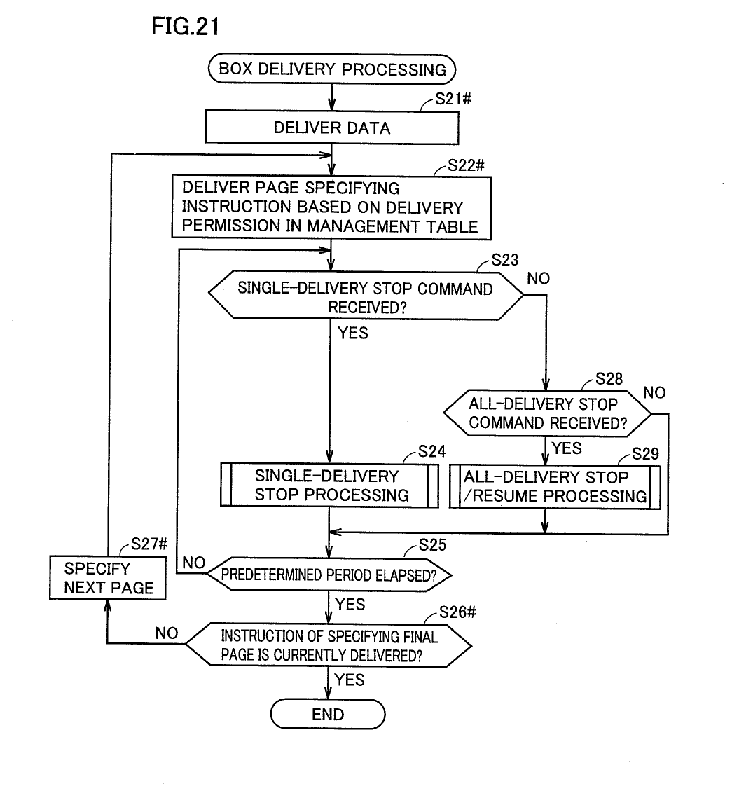

Referring to FIG. 21, description will be given on the BOX delivery processing according to the second embodiment of the invention.

Referring to FIG. 21, in the BOX delivery processing according to the second embodiment of the invention, the data delivery is first executed (step S21#). Specifically, CPU 25 outputs all the delivery data to be delivered to the information processing devices based on predetermined destinations (device identification information) registered in the management table.

Then, CPU 25 delivers a page specifying instruction based on the delivery permission flag in the management table (step S22#).

Subsequent processing in steps S23-S25 is substantially the same as that already described with reference to FIG. 13, and therefore description thereof is not repeated.

When it is determined in step S25 that a predetermined period has elapsed, CPU 25 then determines whether the instruction of specifying the final page is currently delivered or not (step S26#).

When CPU 25 determines in step S26# that the instruction of specifying the final page is not currently delivered, it specifies a next page (step S27#).

Then, the process proceeds to step S22# again. After repeating the above processing, it may be determined in step S26# that the instruction of specifying the final page is currently delivered. In this case, the BOX delivery processing ends (END). By repeating the above processing, MFP 10 transmits collectively all the data (file data consisting of the plurality of pages) to each information processing device, and only the pages to be displayed are specified.

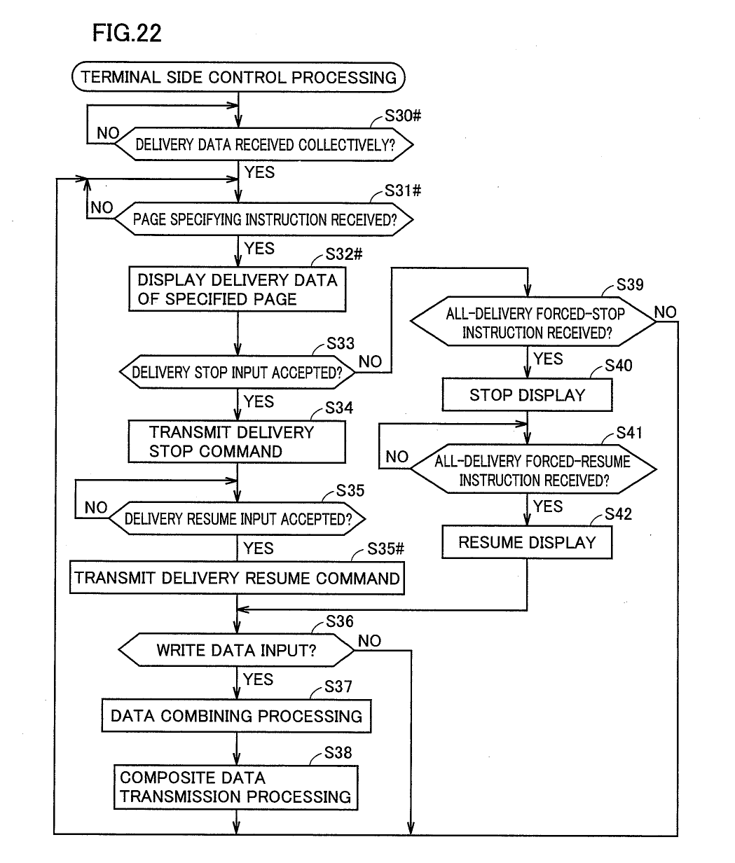

Referring to FIG. 22, description will be given on control processing on the terminal device side according to the second embodiment of the invention.

First, CPU 111 determines whether the collective reception of the delivery data has occurred or not (step S30#). When the collective reception of the delivery data has occurred, CPU 111 stores the collectively received delivery data in a memory 113.

When CPU 111 determines in step S30# that the collective reception of the delivery data has occurred, it determines whether the page specifying indication is received or not (step S31#).

When CPU 111 receives the page specifying indication in step S31#, it displays the delivery data of the specified page in the delivery data stored in memory 113 (step S32#).

Subsequent processing in steps S33-S42 is substantially the same as that already described with reference to FIG. 14, and therefore description thereof is not repeated. The method according to the second embodiment differs from that according to the first embodiment in that the method does not stop the actual data delivery but stops the delivery of the page specifying indication.

In the configuration according to the second embodiment, the delivery data is collectively transmitted to the information processing device, and MFP 10 indicates only the page to be specified for the display. In this configuration, the user can select the single-delivery stop command to stop the delivery of the delivery data to be delivered to his/her own terminal device or the like, and can write the comment, note or the like on the screen. Therefore, it is possible to implement the data delivery system convenient for the users. When the user selects the single-delivery stop command, this selection does not stop the delivery of the delivery data to the other terminal devices or the like, and therefore does not affect the progress of the conference.

When it is necessary to stop the progress of the conference, the user can select the all-delivery stop command so that the delivery of the delivery data to all the devices can be easily stopped, and all the users attending the conference can keep pace with each other.

When the user executes the write input to the delivery data in the terminal device or the like while the delivery of the delivery data is stopped, the HDD stores the composite data so that the data delivery system convenient for the users can be implemented.

### Third Embodiment

The first and second embodiments have been described in connection with the method in which the delivery to all the information processing device is forcedly stopped when the all-delivery stop button is selected in each information processing device.

Instead of the configuration in which the all-delivery stop button is selected to transmit the all-delivery stop command, a third embodiment of the invention will be described below in connection with the method in which the all-delivery stop processing is executed according to the number of the information processing devices to which delivery has been stopped by the single-delivery stop command. The structures of the various devices are the same as those of the first embodiment already described, and therefore description thereof is not repeated.

The third embodiment of the invention does not include all-delivery stop button 134 illustrated in FIG. 15 and includes only single-delivery stop button 132.

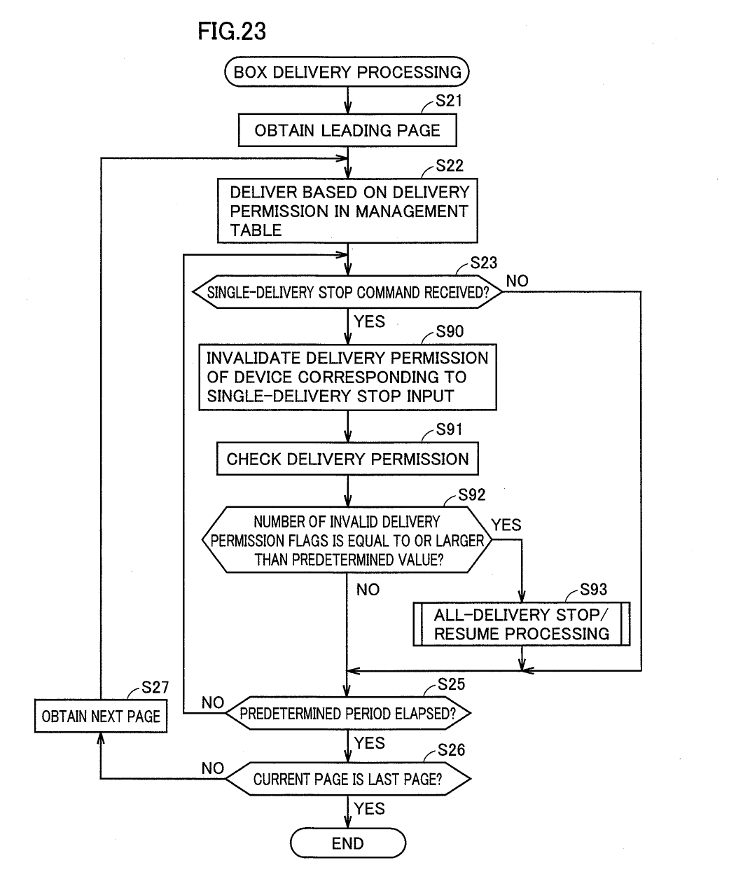

Referring to FIG. 23, description will be given on BOX delivery processing according to the third embodiment of the invention.

Referring to FIG. 23, the BOX delivery processing according to the third embodiment of the invention performs substantially the same steps S21-S23 as the BOX delivery processing illustrated in FIG. 13, and differs therefrom in processing in step S23 and subsequent steps.

In step S23, it is determined whether the single-delivery stop command is received or not (step S23).

In step S23, when CPU 25 receives the single-delivery stop command, it invalidates the delivery permission flag of the device corresponding to the single-delivery stop input (step S90).

Then, CPU 25 checks the delivery permission flag stored in the management table (step S91). Specifically, CPU 25 determines the number of invalid delivery permission flags stored in the management table.

Then, CPU 25 determines whether the number of the invalid delivery permission flags is equal to or more than a predetermined value or not (step S92).

When CPU 25 determines in step S92 that the number of the invalid delivery permission flags is equal to or larger than the predetermined value, it executes the all-delivery stop/resume processing (step S93).

When CPU 25 determines in step S92 that the number of the invalid delivery permission flags is smaller than the predetermined value, it determines whether the predetermined period has elapsed or not (step S25).

When CPU 25 determines in step S25 that the predetermined period has not elapsed, the foregoing processing is repeated. When the predetermined period has elapsed in step S25, the process proceeds to step S26. This processing is substantially the same as that already described, and therefore description thereof is not repeated. Thus, when the number of the invalid delivery permission flags is smaller than the predetermined value, the ordinary single-delivery stop processing that has been described in connection with the foregoing embodiments is executed.

The control processing on the terminal device side is substantially the same as that already described with reference to FIG. 14, and therefore description thereof is not repeated.

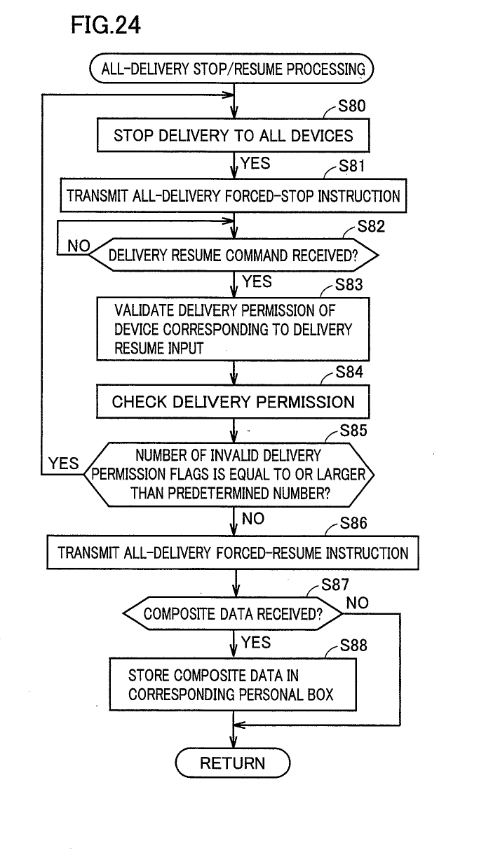

Referring to FIG. 24, description will be given on the all-delivery stop/resume processing according to the third embodiment of the invention.

Referring to FIG. 24, when the all-delivery stop/resume processing is executed, CPU 25 of MFP 10 first stops the delivery to all the devices (step S80). Specifically, when the number of the invalid delivery permission flags stored in the management table is equal to or larger than the predetermined number, CPU 25 stops the delivery to all the devices.

Then, CPU 25 transmits the all-delivery forced-stop instruction to all the devices of the delivery targets through network I/F 21 (step S81). Thereby, each device to which the all-delivery forced-stop instruction is transmitted receives in step S39 of FIG. 14 the all-delivery forced-stop instruction, and display 105 of each device executes the stop display.

Specifically, the display similar to that illustrated in FIG. 20 is performed.

Referring to FIG. 24 again, CPU 25 determines whether it has received the delivery resume command or not (step S82).

When CPU 25 receives the delivery resume command in step S82, it validates the delivery permission flag of the device corresponding to the delivery resume input stored in the management table (step S83).

Then, CPU 25 checks the delivery permission flag stored in the management table (step S84). Specifically, CPU 25 determines the number of the invalid delivery permission flags stored in the management table.

Then, CPU 25 determines whether the number of the invalid delivery permission flags is equal to or larger than the predetermined value or not (step S85).

When CPU 25 determines in step S85 that the number of the invalid delivery permission flags is equal to or larger than the predetermined value, the process returns to step S80, and CPU 25 stops the delivery to all the devices and transmits the all-delivery forced-stop instruction.

Therefore, when the number of the invalid delivery permission flags is equal to or larger than the predetermined number, even the device having transmitted the delivery resume command receives the all-delivery forced-stop instruction and executes the stop display on display 105 similarly to the foregoing processing.

When it is determined in step S85 that the number of the invalid delivery permission flags is smaller than the predetermined number, CPU 25 transmits the all-delivery forced-resume instruction to all the devices of the delivery targets through network I/F 21 (step S86).

Even when the all-delivery forced-resume instruction is transmitted, the delivery of the delivery data to the device that has selected the delivery stop command is not resumed because the delivery permission flag for this device is invalid in the management table.

Then, CPU 25 determines whether the composite data is received or not (step S87). As described before, in the state where the delivery of delivery data has stopped, the user of each device can execute the write input of the comment, note and the like on the display screen. Therefore, the processing in steps S36-S38 in FIG. 14 is executed. When the write input to the delivery data occurs, the data combining processing is performed on the delivery data and the write data in each device as described before, and the composite data thus prepared is transmitted.

Thus, when the user performed the write input to the delivery data, the device transmits the composite data prepared by the data combining processing of the delivery data and the write data, and therefore CPU 25 determines whether it receives the composite data from each device, or not.

When CPU 25 determines in step S87 that the composite data is received, each device stores the composite data in the corresponding personal BOX (step S88). Then, the all-delivery stop/resume processing ends (RETURN).

Thereby, the composite data prepared by the user's write input of the comment, note and the like to the delivery data is stored in the predetermined storage region corresponding to each user name of the personal BOX, as described above.

Referring to FIG. 23 again, the all-delivery stop/resume processing ends, and the process proceeds to step S25 in which it is determined whether the predetermined period has elapsed or not. When the predetermined period has elapsed, the process proceeds to step S26, and the foregoing processing will be repeated. Such a configuration may be employed that when the all-delivery stop/resume processing is executed, the processing in step S25 is not executed, and the process directly proceeds to step S26.

Therefore, the method according to the third embodiment of the invention executes the all-delivery stop processing in accordance with the number of the devices that selected the single delivery stop command. Therefore, the delivery of the delivery data is controlled according to the situation of delivery of the delivery data to the information processing devices of the plurality of users. Thus, the whole delivery stops when many users request the stop of delivery of the delivery data. When only a small number of users request the delivery of the delivery data, the whole delivery does not stop so that the data delivery system convenient for the users can be implemented.

### Fourth Embodiment

A fourth embodiment of the invention will be described below with reference to the method in which specific processing is executed on data contained in the delivery data, and particularly on data in a predetermined page among a plurality of pages forming conference file FA after the delivery processing ends.

Specifically, when the delivery data relates to, e.g., a questionnaire that requests each user to perform the write input, the data is totalized to manage it as one file after the delivery processing. A method of such management will be described below. The structure of each device is substantially the same as that described in connection with the first embodiment, and therefore description thereof is not repeated.

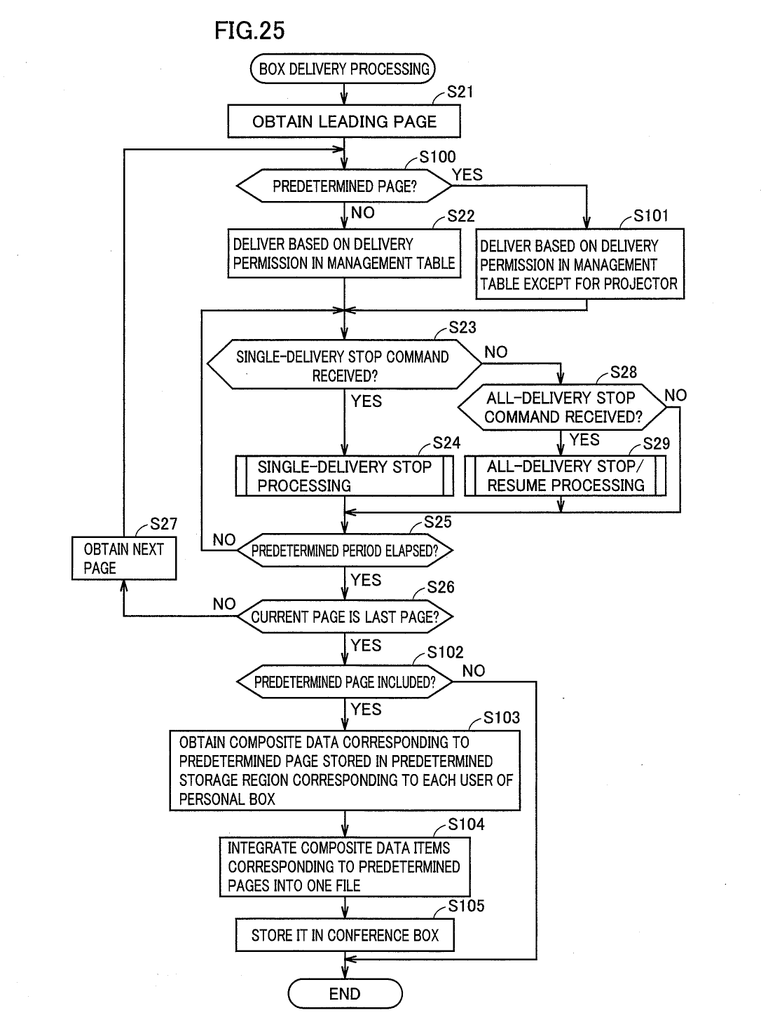

Referring to FIG. 25, description will be given on BOX delivery processing according to the fourth embodiment of the invention.

Referring to FIG. 25, a first page is first obtained (step S21). Specifically, as already described, CPU 25 reads from HDD 26 the data of the first page among the plurality of pages that form selected conference file FA.

Then, CPU 25 determines whether the obtained page among the plurality of pages forming read conference file FA is a predetermined page or not (step S100).

For the determination, the page is configured to bear information such as an identification flag or the like indicating that it is the predetermined page among the plurality of pages forming conference file FA.

For example, CPU 25 determines whether the obtained page bears the identification flag or not. When CPU 25 determines that the page bears the identification flag, it determines that the obtained page is the predetermined page. An example in which the obtained page bears the identification flag is described. However, the identification flag is not restrictive, and other information may be employed provided that it allows the identification that the obtained page is the predetermined page itself different from the other pages.

When CPU 25 determines in step S100 that the obtained page is the predetermined page, CPU 25 performs the delivery based on the delivery permission flag of the management table except for the projector (step S101).

Then, the process proceeds to step S23.

Conversely, when CPU 25 determines that the obtained page is not the predetermined page, the process proceeds to step S22. Subsequent processing in and after step S26 is substantially the same as that illustrated in FIG. 13, and therefore description thereof is not repeated.

When CPU 25 determines in step S26 that the current page is a final page, CPU 25 then determines whether the delivery data contains the predetermined page or not (step S102).

When CPU 25 determines in step S102 that the delivery data includes the predetermined page, CPU 25 obtains the composite data corresponding to the predetermined page stored in the predetermined storage region corresponding to each user in the personal BOX (step S103).

In this example, the data of the predetermined page is data about a questionnaire or the like. Therefore, when the delivery data the an questionnaire is delivered to the information processing device of each user and the write input is executed on the questionnaire or the like, the data combining processing is performed on the write data entered by the wire input and the delivery data, and the composite data is stored in the predetermined storage region corresponding to each user of the personal BOX, according to the manner similar to that already described.

Therefore, CPU 25 obtains the composite data corresponding to the predetermined page from the predetermined storage region corresponding to each user of the personal BOX.

Then, CPU 25 integrates the composite data items corresponding to the predetermined pages into one file (step S104).

Specifically, CPU 25 integrates the composite data items stored in the predetermined storage regions corresponding to the respective users into a file form, and thereby prepares a single item of the composite file data.

CPU 25 stores the composite file data having the file form in the conference BOX (step S105).

Then, the processing ends (END).

The control processing, the single-delivery stop processing, single-delivery resume processing and all-delivery stop/resume processing on the terminal side are substantially the same as those of the first embodiment, and therefore description thereof is not repeated.

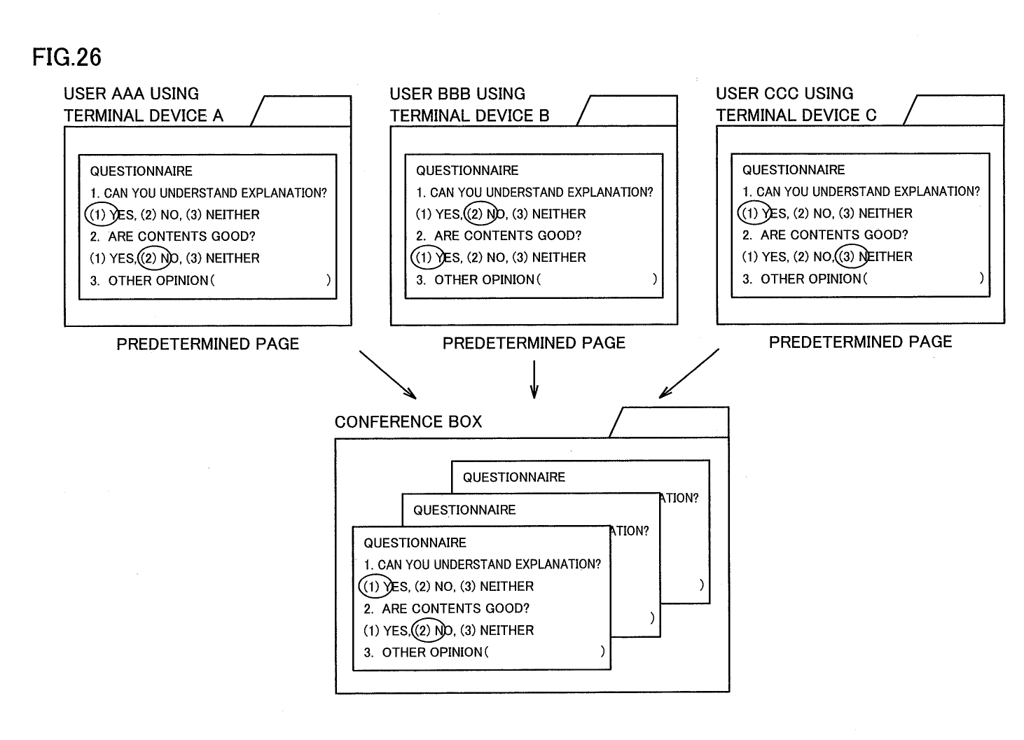

Referring to FIG. 26, description will be given on the preparation of the composite file data in the case where data, e.g., about the questionnaire or the like is in the predetermined page.

In the case shown in FIG. 26, the composite data prepared by executing the write input to the questionnaire or the like is stored in the predetermined storage region of each of users AAA, BBB and CCC using terminal devices A, B and C, respectively.

As already described, CPU 25 integrates the composite data corresponding to the predetermined page to the single file.

Specifically, the composite file data is prepared from the composite data of the questionnaire or the like stored in the predetermined storage region of each user, and is stored in the conference BOX.

According to this processing, a person who prepared the conference file can easily integrate the questionnaire or the like into one file by preparing the conference file containing the predetermined page of the questionnaire or the like. Therefore, the data delivery system convenient for the users can be implemented.

The example has been described in connection with the case where the conference BOX stores the composite file data. Naturally, conference BOX is not restrictive, and another storage region may store the composite file data.

The embodiments have been described in connection with conference system 1 provided with authentication server 200. However, authentication server 200 may be eliminated, and MFP 10 may be configured to have a function of executing the authentication processing.

The embodiments have been described in connection with the method that prepares the management table based on the user information obtained from authentication server 200. However, the management table may be stored in advance in MFP 10. Thus, a manager or administrator may prepare the management table in advance, and the data delivery may be executed based on the delivery permission flags in the management table prepared in advance by the manager.

The structure of the conference system shown in FIG. 1 includes projector 400 and screen 450. However, projector 400 and screen 450 are not essential, and may be eliminated from the structure.

The delivery data that has been primarily described in connection with each embodiment is formed of a plurality of pages bearing the image data. However, the delivery data is not restricted to the image data. The type of the data is not restrictive provided that it can be displayed by display 105 of the terminal device on the receiving side, and the data may be text data and others. For reducing an information quantity of the delivery data, the delivery data may be transmitted and received such that the data is compressed on the transmitting side, i.e., the MFP side and the data is decompressed on the receiving side, i.e., the terminal device side. For enhancing the security, the delivery data may be transmitted and received such that the delivery data is encrypted on the transmitting side, i.e., the MFP side and the data is decrypted on the receiving side, i.e., the terminal device side.

The embodiments of the invention have been described in connection with the method that delivers the delivery data stored in HDD 26 of MFP 10 to each information processing device. However, the MFP is not restrictive, and a PC, printer or the like may be used instead of it. The data is not restricted to the delivery data stored in HDD 26, and may be delivery data stored in another memory. For example, the method may be configured to deliver the delivery data stored in flash memory 30 in FIG. 3.

It is possible to provide a program that causes a computer to execute the control according to the flow described above for implementing the conference system of the invention described above. This program may be provided as a program product by storing the program on a computer-readable recording medium such as a flexible disk, CD-ROM (Compact Disk-Read Only Memory), ROM (Read Only Memory), RAM (Random Access Memory) and memory card annexed to the computer. Also, the program may be provided by recording the program on a recording medium such as an internal hard disk of the computer. Also, the program can be provided by allowing download thereof over a network.

The processing may be executed by calling required modules among program modules, which are provided as a part of an Operation System (OS) of the computer, in a predetermined sequence according to the predetermined timing. In this case, the program itself does not include the above modules, and the processing is executed by cooperation with the OS. This kind of program that does not include the module is likewise the program according to the invention.

The program may be incorporated into a part of another, i.e., different program for providing it. In this case, the program itself does not include the module included in the different program, and the processing is executed by cooperation with the different program. This type of program incorporated into the different program is likewise the program according to the invention.

The provided program product is installed on a program memory such as a hard disk. The program product includes the program itself and the recording medium storing the program.

Although the present invention has been described and illustrated in detail, it is clearly understood that the same is by way of illustration and example only and is not to be taken by way of limitation, the scope of the present invention being interpreted by the terms of the appended claims.

What is claimed is:

1. A data delivery system comprising:
a plurality of information processing devices; and
a data delivery device for delivering a data file including a plurality of pages to said plurality of information processing devices, wherein
each of said information processing devices includes:
a display, and
a first controller for receiving the data file of said plurality of pages delivered from said data delivery device and displaying said data on said display;
said first controller transmits, according to an operation instruction, a delivery stop command instructing said data delivery device to stop the delivery of each of the plurality of pages;
said data delivery device includes:
a memory for storing the data file of said plurality of pages, and
a second controller for performing processing of concurrently delivering successively the plurality of pages to said plurality of information processing devices; and
said second controller is configured to receive the delivery stop command transmitted from said information processing device, and to stop delivery of each of the plurality of pages to at least the information processing device having transmitted the delivery stop command among said plurality of information processing devices.

2. A data delivery device for delivering a data file including a plurality of pages to a plurality of information processing devices, comprising:
a memory for storing the data file of said plurality of pages, and
a controller for performing processing of concurrently delivering successively the plurality of pages to said plurality of information processing devices, wherein
said controller is configured to receive a delivery stop command transmitted from said information processing device, and to stop delivery of each of the plurality of pages to at least the information processing device having transmitted the delivery stop command among said plurality of information processing devices.

3. The data delivery device according to claim 2, wherein
said delivery stop command includes an all-delivery stop command, or a single-delivery stop command, and
when said controller receives the all-delivery stop command, said controller stops the delivery of each of the plurality of pages to all the plurality of information processing devices, and when said controller receives the single-delivery stop command, said controller stops the delivery of each of the plurality of pages to at least the information processing device having transmitted the single-delivery stop command among said plurality of information processing devices.

4. The data delivery device according to claim 3, wherein
when said controller receives the all-delivery stop command, said controller transmits delivery stop information indicating that the delivery of each of the plurality of pages to all the information processing devices has stopped to said plurality of information processing devices.

5. The data delivery device according to claim 3, wherein
when said controller receives an all-delivery resume command instructing resuming of the delivery of each of the plurality of pages to all the plurality of information processing devices, said controller resumes the delivery of each of the plurality of pages to all the plurality of information processing devices, and when said controller receives a single-delivery resume command instructing resuming of the delivery of each of the plurality of pages to at least the information processing device having transmitted the single-delivery resume command among said plurality of information processing devices, said controller resumes the delivery of each of the plurality of pages to at least the information processing device having transmitted the single-delivery resume command among said plurality of information processing devices.

6. The data delivery device according to claim 2, wherein
said memory further stores delivery flags corresponding to said plurality of information processing devices, respectively, for determining from said flag whether the delivery of each of the plurality of pages to the corresponding information processing device is permitted or rejected,
when said controller receives the delivery stop command transmitted from said information processing device, said controller sets the corresponding delivery flag stored in said memory to rejection, and
said controller successively delivers each of the plurality of pages to said plurality of information processing devices according to said delivery flags in said memory.

7. The data delivery device according to claim 6, wherein
said controller stops the delivery of each of the plurality of pages to all the plurality of information processing devices when the number of the delivery flags stored in said memory and indicating the rejection of the delivery is equal to or larger than a predetermined value.

8. The data delivery device according to claim 6, wherein
when said controller receives a delivery resume command transmitted from said information processing device and instructing resuming of the delivery of each of the plurality of pages, said controller sets the corresponding flag stored in said memory to permission, and
said controller resumes the delivery of each of the plurality of pages to all the plurality of information processing devices when the number of the delivery flags stored in said memory and indicating the rejection of the delivery is smaller than a predetermined value.

9. The data delivery device according to claim 2, wherein
said memory further has a plurality of regions arranged corresponding to said plurality of information processing devices for storing the information provided from the corresponding information processing devices, respectively, and
when said controller receives said delivery resume command and receives composite data prepared by performing write input to each of the plurality of pages transmitted from said information processing device having transmitted the delivery resume command, said controller stores said composite data in the corresponding region among said plurality of regions.

10. The data delivery device according to claim 9, wherein
at least one page in the data file including said plurality of pages is a predetermined page, and
said controller is configured to
receive each of the composite data corresponding to the predetermined page from said plurality of information processing devices,
store each of the composite data in the corresponding region among said plurality of regions,
extract each composite data corresponding to the predetermined page stored in each of said regions,
and produce one data file including extracted each composite data.

11. A data delivery device for delivering a data file including a plurality of pages to a plurality of information processing devices, comprising:
a memory for storing the data file of said plurality of pages, and
a controller for performing processing of concurrently delivering the data file in said memory to said plurality of information processing devices, and transmitting information of the page to be displayed, wherein
said controller is configured to receive a delivery stop command transmitted from said information processing device, and to stop transmission of said information of the page to be displayed to at least the information processing device having transmitted the delivery stop command among said plurality of information processing devices.

12. A data delivery method of delivering a data file including a plurality of pages to a plurality of information processing devices, comprising the steps of:
concurrently delivering successively the plurality of pages to said plurality of information processing devices;
receiving a delivery stop command transmitted from said information processing device; and
stopping delivery of each of the plurality of pages to at least the information processing device having transmitted said delivery stop command among said plurality of information processing devices.

13. A recording medium storing a data delivery program to be executed by a computer of a data delivery device connected to a plurality of information processing devices and storing a data file including a plurality of pages, wherein
said data delivery program causes said computer to execute the steps of:
concurrently delivering successively the plurality of pages to said plurality of information processing devices;
receiving a delivery stop command transmitted from said information processing device; and
stopping delivery of each of the plurality of pages to at least the information processing device having transmitted said delivery stop command among said plurality of information processing devices.
